(19) United States
(12) Patent Application Publication
(10) Pub. No.: US 2008/0079626 A1
(43) Pub. Date: Apr. 3, 2008

(54) Methods and Apparatus for Detecting Motion Associated with Sports Equipment.

(75) Inventors: Gregory J. Swartz, Anthem, AZ (US); Mustapha Hayouna, Phoenix, AZ (US)

Correspondence Address: KARSTEN MANUFACTURING CORPORATION, LEGAL DEPARTMENT, 2201 WEST DESERT COVE, PHOENIX, AZ, 85029, US

(73) Assignee: Karsten Manufacturing Corporation, Phoenix, AZ (US)

(21) Appl. No.: 11/865,825

(22) Filed: Oct. 2, 2007

Related U.S. Application Data
(60) Provisional application No. 60/849,061, filed on Oct. 3, 2006.

(51) Int. Cl. G01S 13/50

(52) U.S. Cl. 342/28

(57) ABSTRACT

Embodiments of methods and apparatus for detecting motion associated with sports equipment based on phased array radar are generally described herein. Other embodiments may be described and claimed.

### CROSS REFERENCE TO RELATED APPLICATION(S)

This application claims the benefits of U.S. Provisional Application No. 60/849,061, filed Oct. 3, 2006.

### TECHNICAL FIELD

The present disclosure relates generally to sports equipment, and more particularly, to methods and apparatus for detecting motion associated with sports equipment.

### BACKGROUND

In some sports, equipment fitting processes may match individuals with equipment to help them play to the best of their abilities. In one example, an individual may be custom-fitted for a complete set of golf clubs (e.g., metal woods, irons, wedges, putter, etc.). Different technologies have been implemented to assist equipment fitting processes by measuring and/or calculating various characteristics and/or parameters. For example, impact location, velocity, force, linear acceleration, angular acceleration, orientation and/or other suitable characteristics and/or parameters of a golf club head may be measured and/or calculated. As a result, stance and/or swing patterns of the individual may be determined so that proper sports equipment may be provided to the individual to improve his or her performance.

### DESCRIPTION OF THE DRAWINGS

FIG. 1 is a block diagram representation of an example motion detecting system according to an embodiment of the methods and apparatus disclosed herein.

FIG. 2 is a block diagram representation of example antennas of the example motion detecting system of FIG. 1.

FIG. 3 is a timing diagram representation of the example motion detecting system of FIG. 1.

FIG. 4 is another timing diagram representation of the example motion detecting system of FIG. 1.

FIG. 5 is a flow diagram representation of one manner in which an example motion detecting system of FIG. 1 may be configured to detect motion associated with sports equipment.

### DESCRIPTION

In general, methods and apparatus for sensing motion of sports equipment are described herein. The methods and apparatus described herein are not limited in this regard.

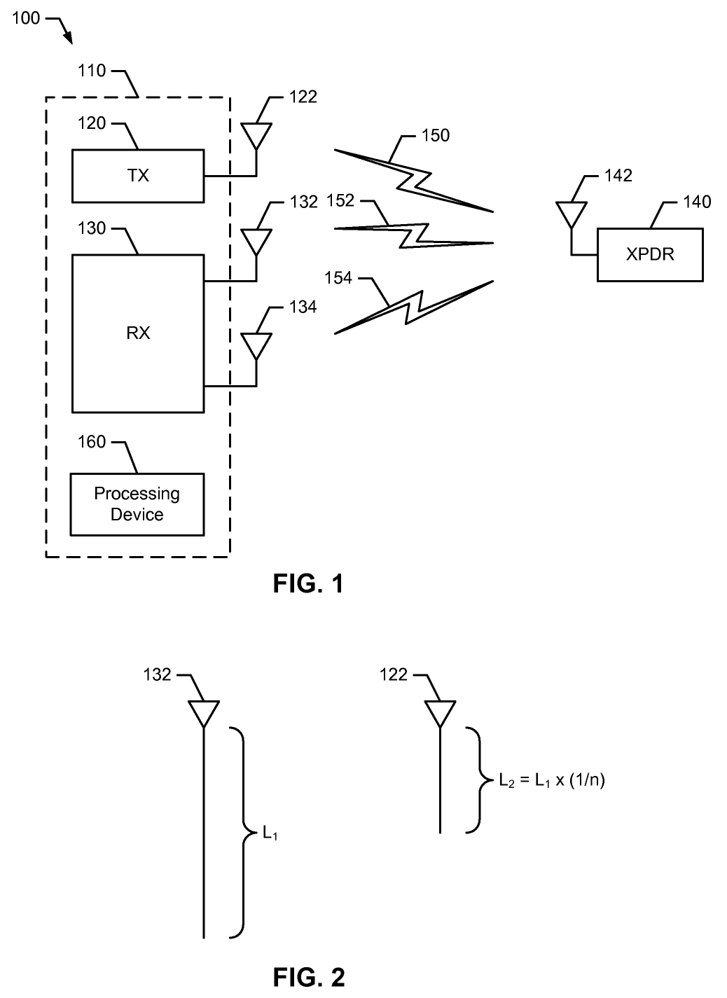

In the example of FIG. 1, a motion detecting system 100 is described herein. In particular, the motion detecting system 100 may include a radar system 110. The radar system 110 may be a phased array radar system. The radar system 110 may be operatively coupled to a processor (not shown) such as a desktop computer, a laptop computer, a handheld computer, a tablet computer, a server, a network, a cellular telephone, a personal digital assistant (PDA), a pager, a gaming device, an audio and/or video player, other suitable types of electronic devices, and/or any combination thereof via one or more wired and/or wireless links.

The radar system 110 may include a transmitter 120 (TX) and a receiver 130 (RX). Although the transmitter 120 and the receiver 130 shown in FIG. 1 are depicted as separate blocks, the transmitter 120 and the receiver 130 may be integrated into a single component. The transmitter 120 may include an antenna 122 to transmit a signal 150 such as an infrared (IR) signal, a microwave signal, an RF signal and/or other suitable type of electromagnetic waves. In one example, the signal 150 may operate in various Industrial Scientific and Medical (ISM) bands.

The receiver 130 may include two or more antennas, generally shown as 132 and 134 (RX_{ANT1} and RX_{ANT2}, respectively). In particular, the antenna 132 may receive a first retransmitted signal 152 whereas the antenna 134 may receive a second retransmitted signal 154. As described in detail below, the phase of the first retransmitted signal 152 may vary relative to the phase of the second retransmitted signal 154.

The motion detecting system 100 may also include one or more transponders, generally shown as 140 (XPDR). In particular, the transponder 140 may receive and retransmit the signal 150. For example, the transponder 140 may be a passive device (e.g., no internal power source) such as a radio frequency (RF) identification (RFID) tag.

In general, the transponder 140 may receive the signal 150 from the transmitter 120 via an antenna 142. For example, the antennas 122 and 142 may be one or more directional or omni-directional antennas such as dipole antennas, monopole antennas, patch antennas, loop antennas, microstrip antennas, and/or other types of antennas suitable for transmission of radio waves. In one example, the antenna 122 may include an arrangement of dipoles in which the phase of each dipole may vary. The antenna 142 may be a full wave antenna, a half-wave antenna, a quarter-wave antenna and/or other suitable types of antenna.

The radar system 110 may also include a processing device 160 operatively coupled to the transmitter 120 and/or the receiver 130. The processing device 160 may process at least one of position information or orientation information associated with the sports equipment. In particular, the processing device 160 may receive position information and/or orientation information from the transponder 140 via the receiver 130. The methods and apparatus described herein are not limited in this regard.

Referring to FIG. 2, for example, the antenna 122 of the transmitter 120 may be associated with a length of L₁. The length of the antenna 142 of the transponder 140 may be associated with a length of L₂. The length of L₂ may be proportional to the length of L₁. In particular, the length of L₂ may be the length of L₁ times a proportionality constant of 1/n.

Although each of the antennas 122 and 142 is depicted as a single straight-line antenna in FIG. 2, the antennas 122 and/or 142 may be associated with a maze-like configuration and/or other suitable type of configuration. The methods and apparatus described herein are not limited in this regard.

Turning back to FIG. 1, the transponder 140 may also include an amplifier (e.g., a resonating diode circuit) to amplify the RF signal from the transmitter 120. While the above examples describe a passive device, the transponder 140 may include an internal power source.

The transponder 140 may be operatively coupled to sports equipment such as golf clubs (e.g., drivers, metal woods, hybrids, irons, putters, etc.). In one example, the transponder 140 may be affixed on, attached to, or within a portion of a golf club such as the grip, the shaft, and/or the club head. Further, the transponder 140 may be removable from the sports equipment. For example, the transponder 140 may be installed on one golf club, removed from that golf club, and reinstalled on another golf club or other sports equipment. In addition or alternatively, the transponder 140 may be operatively coupled to an individual and/or an animal. For example, one or more transponders 140 may be operatively coupled to the hands, the legs, the torso, etc. of an individual.

In addition or alternatively, the motion detecting system 100 may include a reflector (not shown) such as a thin reflecting prism or an inside-corner device. In particular, reflector may reflect the signal 150 from the transmitter 120 to the receiver 130 in a similar manner as described above.

Although FIG. 1 depicts a single transmitter, the motion sensing system 100 may include additional transmitters. In a similar manner, the motion sensing system 100 may include additional receivers and/or transponders. The methods and apparatus described herein are not limited in this regard.

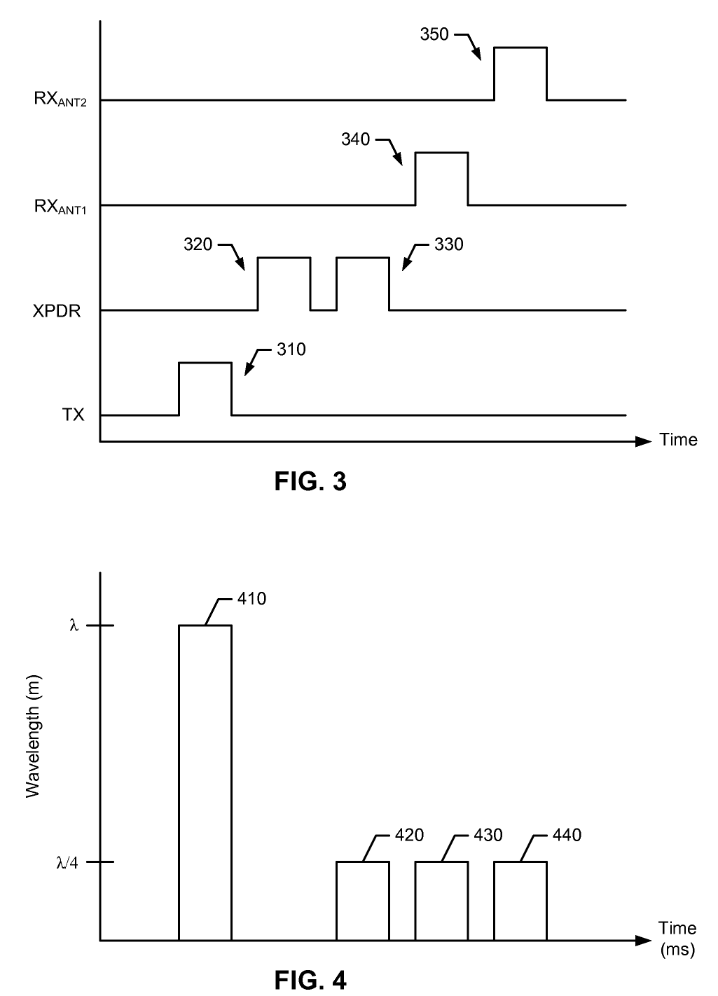

In the example of FIGS. 3 and 4, the transmitter 120 may transmit the signal 150 (310). The signal 150 may be associated with a first wavelength (λ₁) (410). Accordingly, the transponder 140 may receive the signal 150 (320). In turn, the transponder 120 may retransmit the signal 150 (330). In particular, the transponder 140 may transmit a signal with a second wavelength (λ₂) (420). The second wavelength λ₂ may be proportional to the first wavelength λ₁. In one example, the second wavelength λ₂ may be one half of the first wavelength λ₁. In another example, the second wavelength λ₂ may be one quarter of the first wavelength λ₁. The receiver 130 may receive the signal 152 via the antenna 132 (340) and the signal 154 via the antenna 134 (350). Each of the signals 152 and 154 may be associated with the second wavelength λ₂ (430 and 440, respectively). The methods and apparatus described herein are not limited in this regard.

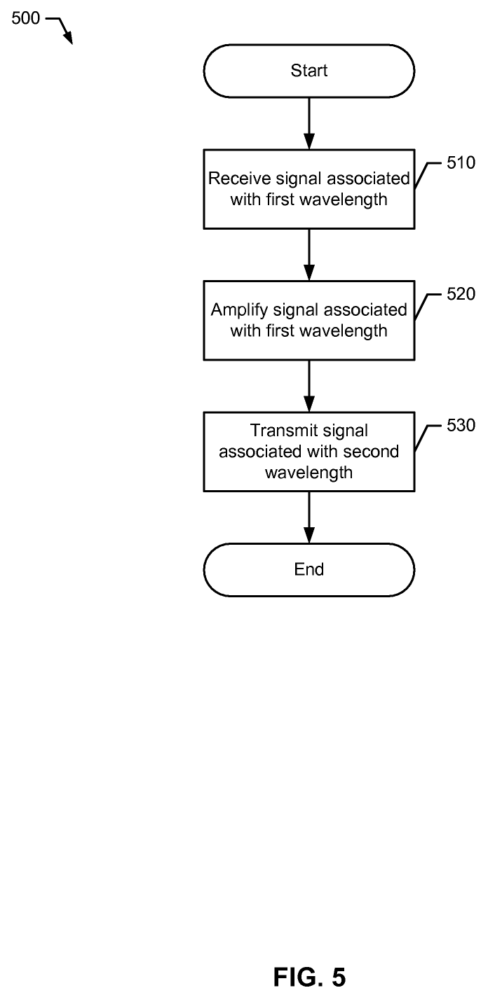

FIG. 5 depicts one manner in which the example transponder 140 may be configured to operate in the motion detecting system 100 of FIG. 1. Although a particular order of actions is illustrated in FIG. 5, these actions may be performed in other temporal sequences.

In the example of FIG. 5, the process 300 begins with the transponder 140 receiving the signal 150 from the transmitter 120 (block 510). As noted above, the signal 150 may be associated with the first wavelength λ₁. The transponder 140 may amplify the signal 150 (block 520). In turn, the transponder 140 may retransmit the signal 150 to the receiver 130. In particular, the transponder 140 may transmit a signal associated with the second wavelength λ₂ (block 530). As noted above, the second wavelength λ₂ may be proportional to the first wavelength λ₁.

Accordingly, the receiver 130 may receive the signal associated with the second wavelength λ₂ (e.g., signals 152 and 154). The signals 152 and 154 may vary in phase (e.g., a phase offset). In one example, the receiver 130 may receive the signal 152 via the antenna 132 and the receiver 130 may receive the signal 154 via the antenna 134. Based on the signals 152 and 154, position and/or orientation information may be determined and/or analyzed. In one example, the motion detecting system 100 may be used to custom fit sports equipment such as golf clubs. In another example, the motion detecting system 100 may be used as a learning tool for individuals. In yet another example, the motion detecting system 100 may be used to assist in developing video games.

While FIG. 5 depicts particular blocks, the process 500 may include additional or fewer blocks. In one example, the process 500 may not include block 520 (i.e., amplify the signal 150). The methods and apparatus described herein are not limited in this regard.

Although the methods and apparatus disclosed herein are described with respect to golf clubs, the methods and apparatus disclosed herein are readily applicable to many other types of sports equipment. In one example, the methods and apparatus described herein may be implemented to detect motion of racquets for badminton, racquetball, squash, tennis, table tennis, etc. In another example, the methods and apparatus described herein may be implemented to detect motion of bats for baseball, cricket, softball, tee ball, etc. In yet another example, the methods and apparatus described herein may be implemented to detect motion of sticks for hockey, lacrosse, polo, etc. The methods and apparatus described herein are not limited in this regard.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

What is claimed is:

1. A method comprising:
receiving a first signal associated with a first wavelength from a transmitter of a radar system to detect motion associated with sports equipment; and
transmitting a second signal associated with a second wavelength to a receiver of the radar system, the second wavelength being proportional to the first wavelength,
wherein the receiver comprises two or more antennas to receive the second signal.

2. A method as defined in claim 1, wherein transmitting the second signal comprises transmitting a signal including at least one of position information or orientation information associated with the sports equipment.

3. A method as defined in claim 1, wherein the second wavelength comprises at least one of one-half of the first wavelength or one-quarter of the first wavelength.

4. A method as defined in claim 1, wherein the first signal comprises at least one of an infrared signal, a microwave signal, or a radio frequency signal.

5. A method as defined in claim 1, wherein the second signal comprises at least one of an infrared signal, a microwave signal, or a radio frequency signal.

6. A method as defined in claim 1, wherein the sports equipment comprises a golf club.

7. A method comprising:
transmitting a first signal associated with a first wavelength via a transmitter of a radar system to detect motion associated with sports equipment; and
receiving a second signal associated with a second wavelength via a receiver of the radar system, the second signal including at least one of position information or orientation information associated with the sports equipment,
wherein the second wavelength being proportional to the first wavelength, and
wherein the receiver comprises two or more antennas to receive the second signal.

8. A method as defined in claim 7 further comprising processing at least one of position information or orientation information associated with the second signal.

9. A method as defined in claim 7, wherein transmitting the first signal comprises transmitting the first signal to a transponder coupled to a portion of the sports equipment.

10. A method as defined in claim 7, wherein receiving the second signal comprises receiving the second signal from a transponder coupled to a portion of the sports equipment.

11. A method as defined in claim 7, wherein the second wavelength comprises at least one of one-half of the first wavelength or one-quarter of the first wavelength.

12. A method as defined in claim 7, wherein the first signal comprises at least one of an infrared signal, a microwave signal, or a radio frequency signal.

13. A method as defined in claim 7, wherein the second signal comprises at least one of an infrared signal, a microwave signal, or a radio frequency signal.

14. A method as defined in claim 7, wherein the sports equipment comprises a golf club.

15. A system comprising:
a transmitter to transmit a first signal associated with a first wavelength to detect motion associated with sports equipment; and
a receiver having two or more antennas to receive a second signal associated with a second wavelength, the second signal including at least one of position information or orientation information associated with the sports equipment,
wherein the second wavelength being proportional to the first wavelength.

16. A system as defined in claim 15 further comprising a processing device to process at least one of position information or orientation information associated with the sports equipment.

17. A system as defined in claim 15, wherein the receiver is operatively coupled to the transmitter to monitor for second signal based on the first signal.

18. A system as defined in claim 15, wherein the second wavelength comprises at least one of one-half of the first wavelength or one-quarter of the first wavelength.

19. A system as defined in claim 15, wherein the first signal comprises at least one of an infrared signal, a microwave signal, or a radio frequency signal.

20. A system as defined in claim 15, wherein the second signal comprises at least one of an infrared signal, a microwave signal, or a radio frequency signal.
